(19) United States
(12) Patent Application Publication
(10) Pub. No.: US 2009/0122239 A1
(43) Pub. Date: May 14, 2009

(54) Color Filter Ink Composition, Method for Making Color Filter, and Color Filter Produced by the Same

(75) Inventors: Jong-Seung PARK, Uiwang-si (KR); In-Jae LEE, Uiwang-si (KR); Jin-Ki HONG, Uiwang-si (KR); Jeong-Min HONG, Uiwang-si (KR); Dong-Seon UH, Seoul (KR); Kyung-Hee HYUNG, Uiwang-si (KR)

Correspondence Address: SUMMA, ADDITON & ASHE, P.A., 11610 NORTH COMMUNITY HOUSE ROAD, SUITE 200, CHARLOTTE, NC, 28277, US

(73) Assignee: Cheil Industries Inc., Gumi-si (KR)

(21) Appl. No.: 12/265,927

(22) Filed: Nov. 6, 2008

(30) Foreign Application Priority Data
Nov. 8, 2007 (KR) 10-2007-0113840

(51) Int. Cl. G02F 1/1335; C08K 5/23; B05D 5/06

(52) U.S. Cl. 349/106; 524/190; 427/256

(57) ABSTRACT

The present invention relates to a color filter ink composition including an acryl-based resin, a polymerizable monomer, a pigment, a leveling agent, and a solvent. The pigment is represented by the following Chemical Formula 1, and the leveling agent is a polymer including a repeating unit including at least one of the following Chemical Formula 2, Chemical Formula 3, or combinations thereof.

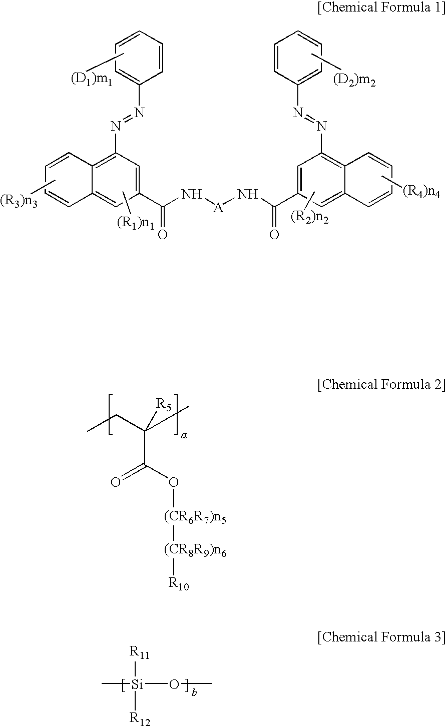

In the above Formulae 1 to 3, each substituent is the same as in the detailed description.

### CROSS-REFERENCE TO RELATED APPLICATION

This application claims priority to and the benefit of Korean Patent Application No. 10-2007-0113840 filed in the Korean Intellectual Property Office on Nov. 8, 2007, the entire disclosure of which is incorporated herein by reference.

### FIELD OF THE INVENTION

The present invention relates to a color filter ink composition, a method of making a color filter, and a color filter produced using the same.

### BACKGROUND OF THE INVENTION

Color filters are used in various applications, such as liquid crystal displays (LCD), optical filters for cameras, and the like. Color filters can be fabricated by coating a fine region colored with more than three colors on a charge coupled device or a transparent substrate. Colored thin films can be commonly fabricated in dyeing, printing, pigment dispersion, and inkjet methods, among others.

Dyeing processes involve forming a colored film by forming an image with a dyeing agent such as a natural photosensitive resin such as gelatin and the like, an amine-modified polyvinyl alcohol, an amine-modified acryl-based resin, and the like on a substrate, and then dyeing the image with direct dyes. In a dyeing process, conventional dyes and resins can have clearance and good dispersion, but light resistance, water resistance, and heat resistance may be reduced.

Printing processes involve forming a colored thin film by printing an ink prepared by dispersing a pigment in a thermally-curable or photocurable resin and curing it with heat or light. This method may decrease material costs compared with other methods, but it can be difficult to form a fine and exact image using printing processes.

Pigment dispersion methods form a colored film by repeating a series of processes such as coating, exposing to light, developing, and curing a photopolymerizable composition including a coloring agent on a transparent substrate with a black matrix. Pigment dispersion methods can improve heat resistance and durability of a color filter and maintain a uniform film thickness. Generally pigment dispersion methods have been used to form colored films because they are easy to apply and can accomplish a fine pattern. For example, Korean patent-laid open No. 92-7002502 and 95-7000359 and Korean patent publication No. 94-5617 and 95-11163 disclose a method of making a color resist using a pigment dispersion method.

However, it can be difficult to manage yield using pigment dispersion methods because each color of red (R), green (G), and blue (B) respectively requires coating, exposure, development, and curing steps to form a pixel. This lengthens the process line and increases the number of factors to be controlled.

Accordingly, conventional pigment dispersion methods have recently been replaced with several new methods, such as inkjet printing methods. Inkjet printing methods involve forming a light proof layer such as a black matrix and the like on a glass substrate, and implanting ink in a pixel space. This method does not require steps such as coating, exposure, development, and the like, and can thereby decrease the amount of materials required for the processes and simplify the whole process line.

When a color filter is fabricated using an inkjet ink method, typically at least two pigments are mixed so as to ensure required color characteristics. For example, when a red filter is fabricated, the main pigment includes a diketopyrolopyrol-based red pigment such as C.I. pigment red No. 254. The mixed pigment is generally prepared by adding an anthraquinone-based red pigment, such as C.I. pigment red No. 177, or an isoindolinone-based yellow pigment, such as C.I. pigment yellow No. 139. As circumstances require, other yellow and orange pigments, such as C.I. pigment yellow No. 138, C.I. pigment yellow No. 150, C.I. pigment orange No. 38, and the like may be added.

These pigments are generally used as color filter materials because of their excellent color characteristics, light resistance, and heat resistance. The requirements for physical properties, however, increase as the number of applications for LCD color filters increase. Accordingly, in order to improve color characteristics such as brightness and color purity when transmitting, there has been a focus on pulverizing and fine-dispersing the pigments. Expression of the color characteristics of color filters by only combining these pigments, however, is limited.

Japanese Patent No. 3924872 disclosed a method of fabricating a color resist by using a novel red pigment. The novel red pigment, however, has a large molecular structure, it is difficult to pulverize, and it is difficult to achieve a particle size of 150 nm or less after being milled. Even after the color filter is fabricated, it is difficult to obtain a desired high quality color filter since the filter has a rough surface and crater surface imperfections frequently occur. In addition, due to the imperfect surface state, a scattering effect is increased which deteriorates the contrast ratio.

### SUMMARY OF THE INVENTION

One embodiment of the present invention provides a color filter ink composition having excellent ejection properties, storage stability, color reproducibility, contrast ratio, spreadability, and planarization, and which is capable of providing a pattern having excellent heat resistance, chemical resistance, color reproducibility, contrast ratio, close contacting property, and good surface states.

Another embodiment of the present invention provides a method of making a color filter pixel using the above color filter ink composition.

A further embodiment of the present invention provides a high quality color filter having a good surface due to low surface roughness and crater occurrence, and excellent color reproducibility and contrast ratio, using the above color filter ink composition.

The embodiments of the present invention are not limited to the above technical purposes, and a person of ordinary skill in the art can understand other technical purposes.

According to one embodiment of the present invention, provided is a color filter ink composition that includes an acryl-based resin, a polymerizable monomer, a pigment represented by the following Chemical Formula 1, a leveling agent, and a solvent. The leveling agent is a polymer including a repeating unit comprising at least one of the following Chemical Formula 2, Chemical Formula 3, or combinations thereof or mixtures thereof.

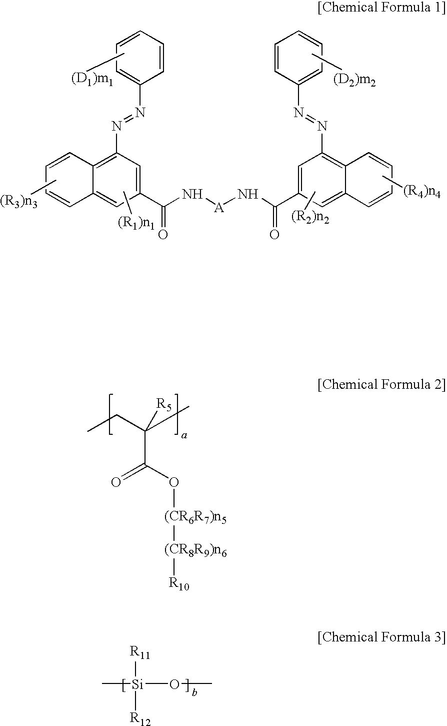

In the above Formulae 1 to 3:

A includes substituted or unsubstituted arylene, substituted or unsubstituted heteroarylene, substituted or unsubstituted cycloalkylene, substituted or unsubstituted heterocycloalkylene, or combinations thereof;

D₁ and D₂ are the same or different and independently include substituted or unsubstituted aryl, substituted or unsubstituted heteroaryl, substituted or unsubstituted cycloalkyl, substituted or unsubstituted heterocycloalkyl, or combinations thereof;

R₁ and R₂ are the same or different and independently include hydroxy, nitro, substituted or unsubstituted amino, cyano, carboxylic acid, or combinations thereof;

R₃ and R₄ are the same or different and independently include hydrogen, substituted or unsubstituted alkyl, substituted or unsubstituted aryl, or combinations thereof;

R₅ to R₇ and R₁₁ to R₁₂ are the same or different and independently include hydrogen, substituted or unsubstituted alkyl, or combinations thereof;

R₈ to R₁₀ are the same or different and independently include halogen, haloalkyl, or combinations thereof;

n₁ and n₂ are the same or different and are independently an integer of 1 or 2;

n₃ and n₄ are the same or different and are independently an integer ranging from 0 to 3;

n₅ is an integer ranging from 0 to 30;

n₆ is an integer ranging from 1 to 20;

m₁ and m₂ are the same of different and are independently an integer ranging from 1 to 5; and

a and b are the same of different and are independently an integer ranging from 1 to 50.

The substituted arylene, substituted heteroarylene, substituted cycloalkylene, substituted heterocycloalkylene, substituted amino, substituted aryl, substituted heteroaryl, substituted cycloalkyl, and substituted heterocycloalkyl refer to arylene, heteroarylene, cycloalkylene, heterocycloalkylene, amino, aryl, heteroaryl, cycloalkyl, and heterocycloalkyl including one or more of a substituent including hydroxyl, halogen, linear or branched alkyl, haloalkyl, cycloalkyl, heterocycloalkyl, alkoxy, aryl, heteroaryl, ester, or combinations thereof.

The color filter ink composition according to the present invention can provide a high quality color filter having a good surface due to low surface roughness and crater occurrence, and excellent color reproducibility and contrast ratio.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

The color filter ink composition according to one embodiment includes an acryl-based resin, a polymerizable monomer, a pigment represented by the following Formula 1, a leveling agent, and a solvent. The leveling agent is a polymer including a repeating unit comprising at least one of the following Chemical Formula 2, Chemical Formula 3, or combinations thereof, or mixtures thereof. Hereinafter, the components of a color filter ink composition according to one embodiment of the present invention are illustrated in detail.

[a] Acryl-Based Resin

The acryl-based resin is a copolymer of a first ethylenic unsaturated monomer and a second ethylenic unsaturated monomer that is copolymerizable with the first ethylenic unsaturated monomer.

Non-limiting examples of the first ethylenic unsaturated monomer useful in the present invention include acrylic acid, methacrylic acid, maleic acid, itaconic acid, fumaric acid, and the like, and combinations thereof.

Non-limiting examples of the second ethylenic unsaturated monomer that is copolymerizable with the first ethylenic unsaturated monomer useful in the present invention include vinyl alkenyl aromatic monomers; unsaturated carbonic acid ester series compounds, unsaturated carbonic acid amino alkyl ester series compounds, carbonic acid vinyl ester series compounds, unsaturated carbonic acid glycidyl ester series compounds, vinyl cyanide compounds, unsaturated amide series compounds, and the like, and combinations thereof.

Specific examples of the second ethylenic unsaturated monomer include styrene, α-methyl styrene; vinyltoluene; vinyl benzyl methyl ester, vinyl benzyl methyl ether; the unsaturated carbonic acid ester series compounds such as but not limited to methyl acrylate, methyl methacrylate, ethyl acrylate, ethyl methacrylate, butyl acrylate, butyl methacrylate, 2-hydroxy ethyl acrylate, 2-hydroxy ethyl methacrylate, 2-hydroxy butyl acrylate, 2-hydroxy butyl methacrylate, benzyl acrylate, benzyl methacrylate, cyclohexyl acrylate, cyclohexyl methacrylate, phenyl acrylate, phenyl methacrylate, and the like, and combinations thereof; unsaturated carbonic acid amino alkyl ester series compounds such as but not limited to 2-amino ethyl acrylate, 2-amino ethyl methacrylate, 2-dimethyl amino ethyl acrylate, 2-dimethyl amino ethyl methacrylate, and the like, and combinations thereof; carbonic acid vinyl ester series compounds such as but not limited to vinyl acetate, vinyl benzoate, and the like and combinations thereof; unsaturated carbonic acid glycidyl ester series compounds such as but not limited to glycidyl acrylate, glycidyl methacrylate, and the like and combinations thereof; vinyl cyanide compounds such as but not limited to acrylonitrile, methacrylonitrile, and the like and combinations thereof; and unsaturated amide series compounds such as but not limited to acryl amide, methacryl amide, and the like, and combinations thereof; as well as combinations of any of the foregoing.

Non-limiting examples of the acryl-based resin include methacrylic acid/benzyl methacrylate copolymer, methacrylic acid/benzyl methacrylate/styrene copolymer, methacrylic acid/benzylmethacrylate/2-hydroxy ethyl methacrylate copolymer, methacrylic acid/benzylmethacrylate/styrene/2-hydroxy ethyl methacrylate copolymer, and the like, and combinations thereof.

The acryl-based resin can have a weight average molecular weight (Mw) of about 3000 to about 150,000, and in one embodiment, about 5000 to about 50,000. When the average molecular weight is less than about 3000, if the molecular weight is too low, the curing rate is slower, and the coating surface can be rough. On the other hand, when the average molecular weight is more than about 150,000, the viscosity can be too high for uniform coating.

The acid value of the acryl-based resin can be about 100 KOH mg/g or less, and in another embodiment, from about 10 to about 100 KOH mg/g. An acid value within this range can improve the developing property and the storage stability of the ink composition.

The acryl-based resin may be included in an amount of about 1 to about 40 wt % based on the total weight of the color filter ink composition. When the amount of acryl-based copolymer resin is less than about 1 wt %, adhesion to the substrate may be insufficient, the thickness of the membrane may not be uniform, and color filter characteristics such as membrane strength, heat resistance, after-image, and so on can deteriorate. When it is more than about 40 wt %, the viscosity can be excessively increased, which can block the nozzle during Inkjet printing, and it can be hard to achieve uniform ejection.

[b] Polymerizable Monomer

The polymerizable monomer may be a generally-used monomer for a color filter photosensitive resin composition, for example dipentaerythrytol hexaacrylate, ethylene glycol diacrylate, triethylene glycol diacrylate, 1,4-butanediol diacrylate, 1,6-hexanediol diacrylate, neopentyl glycol diacrylate, pentaerythrytol diacrylate, pentaerythrytol triacrylate, dipentaerythrytol acrylate, dipentaerythrytol triacrylate, dipentaerythrytol pentaacrylate, pentaerythrytol hexaacrylate, bisphenol A diacrylate, trimethylolpropane triacrylate, novolacepoxyacrylate, ethylene glycol dimethacrylate, diethylene glycol dimethacrylate, triethylene glycol dimethacrylate, propylene glycol dimethacrylate, 1,4-butanediol dimethacrylate, 1,6-hexanediol dimethacrylate, and the like, and combinations thereof.

The polymerizable monomer is added in an amount of about 1 to about 20 wt % based on the total weight of the color filter ink composition. When the amount of the polymerizable monomer is less than about 1 wt %, the membrane strength can deteriorate because the pattern may be insufficiently hardened. On the other hand, when it is more than about 20 wt %, the viscosity of the ink composition can increase and the storage stability can deteriorate, so that it can be difficult to maintain the ink characteristics.

[c] Pigment

The pigment may include a main pigment of a red pigment having at least one azo group represented by the following Chemical Formula 1.

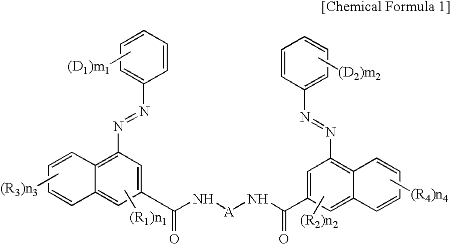

In the above Formula 1, A includes substituted or unsubstituted arylene, substituted or unsubstituted heteroarylene, substituted or unsubstituted cycloalkylene, substituted or unsubstituted heterocycloalkylene, or combinations thereof.

D₁ and D₂ are the same or different and independently include substituted or unsubstituted aryl, substituted or unsubstituted heteroaryl, substituted or unsubstituted cycloalkyl, substituted or unsubstituted heterocycloalkyl, or combinations thereof.

Examples of A include without limitation:

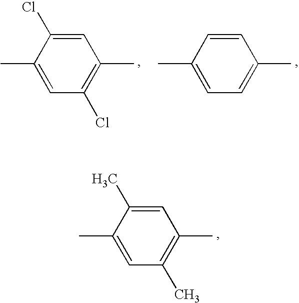

and the like, and combinations thereof.

Examples of D₁ and D₂ include without limitation substituted benzenes such as:

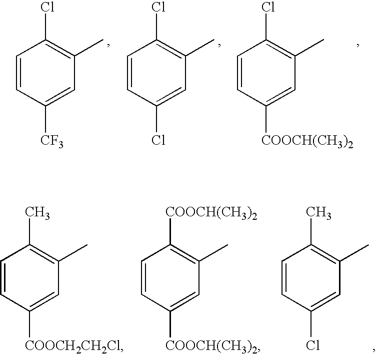

and the like, and combinations thereof.

R₁ and R₂ are the same or different and independently include hydroxy, nitro, substituted or unsubstituted amino, cyano, carboxylic acid, or combinations thereof.

R₃ and R₄ are the same or different and independently include hydrogen, substituted or unsubstituted alkyl, substituted or unsubstituted aryl, or combinations thereof.

n₁ and n₂ are the same or different and are independently an integer of 1 or 2.

n₃ and n₄ are the same or different and are independently an integer ranging from 0 to 3.

m₁ and m₂ are the same of different and are independently an integer ranging from 1 to 5.

The pigment of the above Formula 1 includes a compound having the following Formula 4.

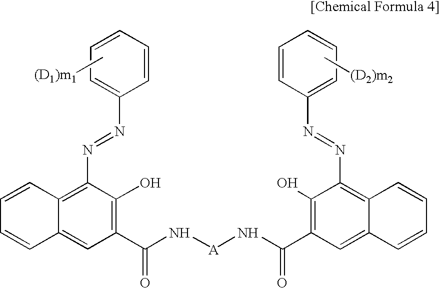

In the above Formula 4, each substituent is the same as defined in Chemical Formula 1.

In the present specification, when specific definition is not provided, the term “substituted” refers to a compound substituted with at least one or more substituents including hydroxyl, halogen, linear or branched alkyl, haloalkyl, cycloalkyl, heterocycloalkyl, alkoxy, aryl, heteroaryl, ester, or combinations thereof.

In the present specification, when specific definition is not provided, “an alkyl” refers to a C₁ to C₃₀ alkyl, for example a C₁ to C₁₈ alkyl, “a cycloalkyl” refers to a C₃ to C₂₀ cycloalkyl, for example a C₃ to C₁₀ cycloalkyl, “a heterocycloalkyl” refers to a C₂ to C₂₀ heterocycloalkyl, for example a C₂ to C₁₀ heterocycloalkyl, “an alkoxy” refers to a C₁ to C₂₀ alkoxy, for example a C₁ to C₁₀ alkoxy, and as another example a C₁ to C₄ alkoxy, “an aryl” refers to a C₆ to C₄₀ aryl, for example a C₆ to C₂₀ aryl, “a heteroaryl” refers to a C₂ to C₃₀ heteroaryl, for example a C₂ to C₁₈ heteroaryl, “an ester” refers to a C₁ to C₂₀ ester, for example a C₁ to C₁₀ ester, “a cycloalkylene” refers to a C₃ to C₂₀ cycloalkylene, for example a C₃ to C₁₀ cycloalkylene, “a heterocycloalkylene” refers to a C₂ to C₂₀ heterocycloalkylene, for example a C₂ to C₁₀ heterocycloalkylene, “an arylene” refers to a C₆ to C₁₄ arylene, for example a C₆ to C₁₀ arylene, and “a heteroarylene” refers to a C₅ to C₁₃ heteroarylene, for example a C₅ to C₉ heteroarylene.

The “heterocycloalkyl,” “heterocycloalkylene”, “heteroaryl”, or “heteroaryl” refer to compounds including 1 to 20, for example 1 to 15, and as another example 1 to 5 heteroatoms including N, O, S, Si, or combinations thereof.

Specific examples of the main pigments include without limitation compounds that are classified as pigments according to the Color Index. The compounds may include C.I. pigment red 242, C.I. pigment red 214, C.I. pigment red 221, C.I. pigment red 166, C.I. pigment red 220, C.I. pigment red 248, or C.I. pigment red 262, which may be used as a main pigment singularly or mixed with at least two or more thereof.

In order to ensure the color characteristic, the main pigment may be mixed with a co-pigment having excellent light resistance and heat resistance. Representative examples of the co-pigment include but are not limited to C.I. pigment red 177, C.I. pigment yellow 139, C.I. pigment yellow, No. 138, C.I pigment yellow No. 150, C.I. pigment orange No. 38, and combinations thereof.

The pigment may be included in an amount of about 1 to about 40 wt %, for example in one embodiment about 5 to about 20 wt %, and in another embodiment about 5 to about 15 wt % based on the total weight of the color filter ink composition. When the amount of the pigment is less than about 1 wt %, it can be impossible to obtain the required color reproducibility. On the other hand, when it is more than about 40 wt %, the dispersion stability can deteriorate and the contrast ratio is not ensured. In addition, when the pigment is provided by mixing the main pigment with the co-pigment, the co-pigment can be added in amount of about 1 to about 20 wt % based on the total weight of the color filter ink composition. Within this range, it can be possible to move the desired level of the final color space for the mixed ink and to improve the contrast ratio and the brightness of the ink.

[d] Leveling Agent

The leveling agent is selected from the group consisting of fluorine-based compounds, silicon-based compounds, and combinations thereof. Examples of the leveling agent include without limitation a polymer including a repeating unit comprising at least one of the following Chemical Formula 2, Chemical Formula 3, or combinations thereof, or mixtures thereof.

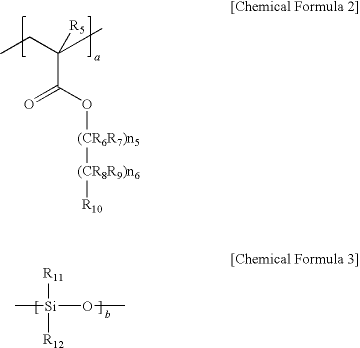

In the above Formulae 2 and 3,

R₅ to R₇ and R₁₁ to R₁₂ are the same or different and independently include hydrogen, substituted or unsubstituted alkyl, or combinations thereof; and

R₈ to R₁₀ are the same or different and independently include halogen (F, Cl, Br, or I), haloalkyl (alkyl where at least one hydrogen is substituted with halogen), or combinations thereof. Specific examples of the halogen and haloalkyl include without limitation fluoro and fluoro alkyl.

a and b are the same of different and are independently an integer ranging from 1 to 50,

n₅ is an integer ranging from 0 to 30, for example 1 to 20, and

n₆ is an integer ranging from 1 to 20.

The polymer including a repeating unit of the above Formula 2 or 3 includes a compound represented by the following Formulae 5 and 6.

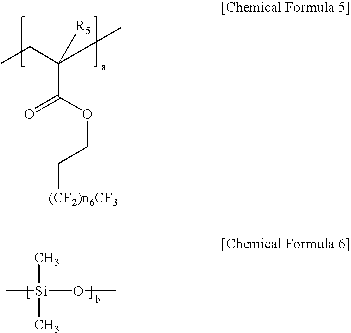

In the above Formulae 5 and 6, each substituent is the same as in Chemical Formulae 2 and 3.

The leveling agent is included in an amount of about 0.001 to about 2.0 wt % based on the total weight of the color filter ink composition. When the leveling agent is added in an amount of less than about 0.001 wt %, the spreadability and the planarization of ink may be insufficient, which can increase surface roughness and generate surface craters when the ink composition including the red pigment is dried. On the other hand, when there is more than about 2.0 wt % of the leveling agent, the spreadability can be excessive so that ink that overflows from the printing head can leak or spatter on a black matrix surface and an opening area of an adjacent pixel, and thereby contaminate them.

The leveling agent increases the degree of spreadability and planarization of the color filter ink composition so that it can prevent the problems caused while the color filter surface is being formed in the drying process, for example the increase of surface roughness, the occurrence of surface craters, and the like. As mentioned above, a red pigment has a larger molecular structure and is hard to pulverize, so that it can be difficult to pulverize it to a particle diameter of 150 nm or less. Adding the leveling agent, however, can provide a fine dispersion of the pigment, thereby solving these problems.

In addition, by adding the leveling agent, the interfacial tension of the ink composition can be decreased to about 30 mN/m or less. When the interfacial tension is about 30 mN/m or less, the spreadability of ink is ensured to provide a color filter with a uniform surface.

[e] Solvent

The solvent may include any solvent having high solubility toward the acryl-based resin and good affinity for a pigment dispersion to maintain the high dispersion. According to an exemplary embodiment, the solvent may include a high boiling-point solvent. The high boiling-point solvent can solve the problem of blocking the nozzle when printing and can ensure the color characteristics of the color filter.

The high boiling-point solvent can have a boiling point of about 170 to about 250° C., but is not limited thereto.

The high boiling-point solvent may include 3-methoxy butyl acetate, diethylene glycol methyl ether acetate, diethylene glycol ethyl ether acetate, diethylene glycol butyl ether acetate, ethylene glycol butyl ether acetate, 1,3-butanediol diacetate, propylene glycol n-propyl ether acetate, propylene glycol n-butyl ether acetate, dipropylene glycol n-propyl ether acetate, dipropylene glycol n-butyl ether acetate, propylene glycol diacetate, dipropylene glycol propyl ether, dipropylene glycol butyl ether, tripropylene glycol methyl ether, diethylene glycol dibutyl ether, tripropylene glycol butyl ether, or the like, or combinations thereof.

Furthermore, according to another embodiment, the solvent can be prepared by mixing a solvent with a low boiling-point of less than about 170° C. with a high boiling-point solvent to improve color reproducibility, contrast ratio, and storage stability of ink in order to produce the color filter.

The low boiling-point solvent may include ethylacetate, n-butylacetate, isobutylacetate, isopropylacetate, n-propylacetate, propylene glycol methyl ether acetate, propylene glycol ethyl ether acetate, 3-methoxy-1-propyl acetate, ethylene glycol methyl ether acetate, ethylene glycol ethyl ether acetate, propylene glycol methyl ether, propylene glycol ethyl ether, propylene glycol propyl ether, propylene glycol diacetate, ethylene glycol propyl ether, n-butyl propionate, 3-ethoxy propionate ethyl, n-pentyl propionate, n-propyl propionate, propylene glycol methyl ether propionate, or the like, or combinations thereof.

The high boiling-point solvent and the low boiling-point solvent can be used in a weight ratio of about 99:1 to about 50:50. When the amount of the high boiling-point solvent is less than this ratio, the drying rate of ink can increase due to the rapid volatilization of solvent, causing frequent blocking of the nozzle so that it is difficult to maintain the desirable ejection performance. On the other hand, when it is more than this ratio, it can be difficult to uniformly eject ink, and the dispersion and storage stability can deteriorate, so that it is difficult to maintain the high contrast ratio.

The amount of the solvent may be the balance, but in another embodiment, the solvent is included in amount of about 40 to about 90 wt % based on the total weight of the color filter ink composition. When the solvent is less than about 40 wt %, the ejection properties can remarkably deteriorate so it can be impossible to print. On the other hand, when it is more than about 90 wt %, the ink can leak from the head nozzle, which can make it impossible to obtain the desirable color characteristics after forming a pattern.

[f] Polymerization Initiator

The color filter ink composition may further include a polymerization initiator to improve pattern strength. The polymerization initiator may include photo polymerization initiators, thermal polymerization initiators, or combinations thereof.

Non-limiting examples of the photo polymerization initiator useful in the invention include acetophenone-based compounds, benzophenone-based compounds, thioxanthone-based compounds, benzoin-based compounds, triazine-based compounds, and the like, and combinations thereof.

Non-limiting examples of the acetophenone-based compound useful in the invention include 2,2′-diethoxyacetophenone, 2,2′-dibutoxyacetophenone, 2-hydroxy-2-methylpropiophenone, p-t-butyltrichloroacetophenone, p-t-butyldichloroacetophenone, 4-chloroacetophenone, 2,2′-dichloro-4-phenoxyacetophenone, 2-methyl-1-(4-(methylthio)phenyl)-2-morpholinopropan-1-one, 2-benzyl-2-dimethylamino-1-(4-morpholinophenyl)-butan-1-one, and the like, and combinations thereof.

Non-limiting examples of the benzophenone-based compound useful in the invention include benzophenone, benzoyl benzoate, benzoyl methyl benzoate, 4-phenyl benzophenone, hydroxy benzophenone, acrylated benzophenone, 4,4′-bis(dimethyl amino)benzophenone, 4,4′-bis(diethylamino)benzophenone, 4,4′-dimethyl aminobenzophenone, 4,4′-dichlorobenzophenone, 3,3′-dimethyl-2-methoxy benzophenone, and the like, and combinations thereof.

Non-limiting examples of the thioxanthone-based compound useful in the invention include thioxanthone, 2-crolthioxanthone, 2-methylthioxanthone, isopropyl thioxanthone, 2,4-diethyl thioxanthone, 2,4-diisopropyl thioxanthone, 2-chlorothioxanthone, and the like, and combinations thereof.

Non-limiting examples of the benzoin-based compound useful in the invention include benzoin, benzoin methyl ether, benzoin ethyl ether, benzoin isopropyl ether, benzoin isobutyl ether, benzyldimethylketal, and the like, and combinations thereof.

Non-limiting examples of the triazine-based compound useful in the invention include 2,4,6,-trichloro s-triazine, 2-phenyl 4,6-bis(trichloromethyl)-s-triazine, 2-(3′,4′-dimethoxystyryl)-4,6-bis(trichloromethyl )-s-triazine, 2-(4′-methoxynaphthyl)-4,6-bis(trichloromethyl)-s-triazine, 2-(p-methoxyphenyl)-4,6-bis(trichloromethyl)-s-triazine, 2-(p-tolyl)-4,6-bis(trichloromethyl)-s-triazine, 2-biphenyl4,6-bis(trichloromethyl)-s-triazine, bis(trichloromethyl)-6-styryl s-triazine, 2-(naphto1-yl)-4,6-bis(trichloromethyl)-s-triazine, 2-(4-methoxynaphto1-yl )-4,6-bis(trichloromethyl )-s-triazine, 2-4-trichloromethyl(piperonyl)-6-triazine, 2-4-trichloromethyl (4′-methoxystyryl)-6-triazine, and the like, and combinations thereof.

The photo polymerization initiator may further include a carbazole-based compound, a diketone-based compound, a sulfonium borate-based compound, a diazo-based compound, a biimidazole-based compound, or the like, or combinations thereof.

The thermal polymerization initiator may include a generally-used peroxide-based compound. Non-limiting examples of the peroxide-based compound useful in the invention include methylethylketone peroxide; methylisobutal ketone peroxide; cyclohexanone peroxide; acetylacetone peroxide; isobutyryl peroxide; and hydroperoxide series compounds such as diisoprobenzene hydroperoxide, cumenehydroperoxide, and t-butylhydroperoxide, and the like, and combinations thereof.

Non-limiting examples of the thermal polymerization initiator useful in the invention include peroxyketal series compounds such as 1,1-di-t-butylperoxy-3,3,5-trimethylcyclohexane, 2,2-di-(t-butyloxyisopropyl)benzene, 4,4-di-t-butylperoxyvaleric acid n-butylester, and the like, and combinations thereof.

When the color filter ink composition further includes the polymerization initiator, the polymerization initiator may be included in an amount of about 0.1 to about 10 wt % based on the total weight of the color filter ink composition. When the initiator is included in an amount of less than about 0.1 wt %, it may not improve pattern strength. However, when it is included in an amount of more than about 10 wt %, it may deteriorate storage stability and gradually increase viscosity, deteriorating ejection performance.

[g] Other Additives

The color filter ink composition may selectively include a dispersing agent to improve dispersion of a pigment. The dispersing agent enables pigment particulate dispersion to improve pigment dispersion.

The dispersing agent may include a non-ionic, anionic, or cationic dispersing agent. For example, it may include polyalkylene glycol and an ester thereof, polyoxyalkylene, a polyhydric alcohol ester alkylene oxide additive, an alcoholalkyleneoxide additive, sulfonic acid ester, sulfonate, carboxylic acid ester, carboxylate, an alkylamide alkylene oxide additive, an alkylamine, and the like. These dispersing agents can be used singularly or in combination of two or more. The dispersing agent may be included in an amount of about 10 to about 20 parts by weight based on 100 parts by weight of a pigment.

In addition, the color filter ink composition may further include an adhesion improving agent to improve its adhesion to a substrate. The coating and adhesion improving agents can be included in an amount of about 0.01 to about 1 wt % based on the total weight of the color filter ink composition.

Another embodiment of the present invention provides a method of making a pixel for a display color filter using the color filter ink composition.

The method of making a pixel of a display color filter includes coating the ink composition on a substrate using an Inkjet spraying method to form a pattern (S1), and curing the pattern (S2).

Pattern Formation (S1)

The color filter ink composition can be coated to be about 0.5 to about 3.0 μm thick on a substrate in an Inkjet dispersion method. The Inkjet dispersion method can form a pattern by repeatedly dispersing desired colors one by one or simultaneously dispersing the desired colors to simplify the process.

Curing (S2)

The pattern is cured, acquiring a pixel. The curing may include optic curing, thermal curing, and the like. The thermal curing may be appropriate in one embodiment. The thermal curing may be performed at a temperature of higher than about 160° C., in one embodiment at about 160 to about 300° C., and in another embodiment at about 200 to about 250° C.

According to still another embodiment of the present invention, a color filter made using the color filter ink composition is provided.

Hereinafter, the present invention is illustrated in more detail with reference to examples. However, these are exemplary embodiments of present invention and are not limiting.

### EXAMPLE 1

### Preparation of a Color Filter Ink Composition

| (a) acryl-based resin | 6 | wt % |
|---|---|---|
| benzylmethacrylate/cyclohexylmethacrylate/ | | |
| styrene/methacrylic acid copolymer | | |
| (mole ratio of monomers = 40/36/15/10, | | |
| weight average molecular weight = 20,000) | | |
| (b) polymerizable monomer | 6 | wt % |
| dipentaerythrytolhexaacrylate | | |
| (c) pigment | 15 | wt % |
| C.I. pigment red No. 242/C.I. pigment red | | |
| No. 177 = 50/40 (parts by weight) | | |
| (e) solvent | balance | |
| diethylene glycol butyl ether acetate | 46 | parts by weight |
| diethylene glycol ethyl ether acetate | 32.5 | parts by weight |
| (e) leveling agent (fluorine-based surfactant) | 0.5 | wt % |
| MEGAFACE F475 (made by DIC) | | |

The above components are used to prepare an ink composition.

### EXAMPLE 2

### Preparation of a Color Filter Ink Composition

An ink composition is prepared in accordance with the same procedure as in Example 1, except that the pigment of Example 1 is substituted with 15 wt % of C.I. pigment red No. 242/C.I. pigment red No. 214/C.I. pigment red No. 177=25/25/40 (parts by weight).

### EXAMPLE 3

### Preparation of a Color Filter Ink Composition

An ink composition is prepared in accordance with the same procedure as in Example 1, except that the leveling agent of Example 1 is added at 1.0 wt %.

### EXAMPLE 4

### Preparation of a Color Filter Ink Composition

An ink composition is prepared in accordance with the same procedure as in Example 1, except that 1.0 wt % of a leveler SH-8400 (made by DIC) is used as a leveling agent.

### EXAMPLE 5

### Preparation of a Color Filter Ink Composition

An ink composition is prepared in accordance with the same procedure as in Example 1, except that a diethylene glycol butyl ether acetate/diethylene glycol ethyl ether acetate/propylene glycol methyl ether acetate=40/30/8.5 (parts by weight) is used as a solvent.

### EXAMPLE 6

### Preparation of a Color Filter Ink Composition

An ink composition is prepared in accordance with the same procedure as in Example 1, except that 0.5 wt % of a polymerization initiator, TAZ-110 (manufactured by Midori), is used based on the total amount of ink composition for the color filter.

### COMPARATIVE EXAMPLE 1

### Preparation of a Color Filter Ink Composition

An ink composition is prepared in accordance with the same procedure as in Example 1, except that the leveling agent is not used.

### COMPARATIVE EXAMPLE 2

### Preparation of a Color Filter Ink Composition

An ink composition is prepared in accordance with the same procedure as in Example 1, except that the leveling agent is substituted with 0.0005 wt % of a Megaface F475 (manufactured by Toray-Dow Corning Inc.).

### COMPARATIVE EXAMPLE 3

### Preparation of a Color Filter Ink Composition

An ink composition is prepared in accordance with the same procedure as in Example 1, except that the pigment of Example 1 is substituted with 15 wt % of C.I. pigment red No. 254/C.I. pigment red 1 No. 77=75/15 (parts by weight).

Measurement of Material Property of Color Filter Ink Composition

Color filter ink compositions prepared in Examples 1 to 6 and Comparative Examples 1 to 3 are evaluated as follows, and the results are shown in the following Table 1.

1. Contrast Ratio Analysis

A color film ink composition prepared from each of Examples 1 to 6 and Comparative Examples 1 to 3 is coated on a surface of a 1 mm thick cleaned and washed glass substrate in a thickness of 1 to 2 μm and dried on a hot plate at 80° C. for 1 minute to provide a coating film. The obtained coating film is dried in a hot air-circulating dryer at 220° C. for 40 minutes, and then the contrast ratio is observed through a spectrophotometer and contrast ratio measurement meter.

In the following Table 1, ⊚ refers to 1200:1 or more, ∘ ranges from 1000:1 to 1200:1, Δ ranges from 800:1 to 1000:1, and × refers to 800:1 or less.

2. Ejection Properties Assessment

A color filter ink composition prepared in each of Examples 1 to 6 and Comparative Examples 1 to 3 is sprayed on normal paper once to produce a certain drop size of 2 pL, and after 10 seconds a second spray is performed. Then, after a 20 second interval, the spraying is performed again, and the interval is subsequently repeatedly increased to determine the length of an interval before any one of the ink jet head nozzles did not uniformly eject the color filter ink composition.

In the following Table 1, ⊚ refers to a case in which normal ejection is possible even when the interval is 300 or more seconds; ∘ refers to a case in which the interval is 200 to 300 seconds; Δ refers to the case in which the interval is 100 to 200 seconds; and × refers to the case in which the normal ejection is only possible up to an interval of less than 100 seconds. In addition, an imperfection is determined even when a nozzle is not blocked but did not correctly eject or when the ejected ink did not reach the desired pixel.

3. Storage and Dispersion Stability Assessment

Ink compositions prepared in Examples 1 to 8 and Comparative Examples 1 to 3 are stored at the same temperature of 40° C. for one week and measured to determine viscosity.

In Table 1, ⊚ refers to a viscosity that is not changed and in which no impurity is generated by observing the outside of the ink; ∘ refers to a viscosity that is changed within a range of 0.1 to 0.5 cPs but the impurity is not generated; A refers to a viscosity that is changed within a range of 0.5 to 1.0 cPs and the impurity is not generated; and × refers to a viscosity that is remarkably increased by 1.0 cPs or more, or the impurity is generated due to recrystalization.

4. Heat Resistance Assessment

Each of the color filter ink compositions prepared in Examples 1 to 6 and Comparative Examples 1 to 3 is uniformly coated on a glass substrate and stored at 230° C. for 1 to 3 hours to determine color change.

In the following Table 1, ⊚ refers to no pattern change and a color difference (ΔE) of less than 0.1 after 3 hours of heat treatment; ⊚ refers to 1.0<ΔE<3.0 after 3 hours of heat treatment; Δ refers to ΔE>3.0 after 3 hours of heat treatment but ΔE<3.0 after 1 hour of heat treatment; and × refers to ΔE>3.0 after 1 hour of heat treatment in which the color change is remarkably recognized with the naked eye.

5. Surface Roughness Assessment

Each of the color filter ink compositions prepared in Examples 1 to 6 and Comparative Examples 1 to 3 is uniformly coated on a glass substrate and dried at 230° C. for one hour to measure irregularity of pattern height.

In the following Table 1, ⊚ refers to a case in which the pattern height difference of the same substrate (ΔH) is ±0.1 or less; ∘ refers to a height difference (ΔH) ranging from ±0.1 to ±0.2; Δ refers to a height difference (ΔH) ranging from ±0.2 to ±0.3; and × refers to a height difference (ΔH) of ±0.3 or more.

6. Surface Characteristic Assessment

Each of the color filter ink compositions prepared in Examples 1 to 6 and Comparative Examples 1 to 3 is uniformly coated on a glass substrate and dried at 230° C. for one hour to determine the number of craters on the color filter surface with an optical microscope.

In the following Table 1, ⊚ refers to no craters (depressed portions) being generated in the same substrate; ∘ refers to generation of 1 to 5 craters; Δ refers to generation of 6 to 9 craters; and × refers to generation of 10 or more craters.

TABLE 1

| | | | Storage/ | | | |
|---|---|---|---|---|---|---|
| | | Ejection | dispersion | Heat | Surface | Surface |
| | Contrast ratio | properties | stability | resistance | roughness | characteristic |
| Example 1 | ◯ | ⊚ | ◯ | ◯ | ◯ | ◯ |
| Example 2 | ⊚ | ⊚ | ◯ | ◯ | ◯ | ◯ |
| Example 3 | ◯ | ⊚ | ◯ | ◯ | ⊚ | ⊚ |
| Example 4 | ◯ | ⊚ | ◯ | ◯ | ◯ | ⊚ |
| Example 5 | ◯ | ◯ | ⊚ | ◯ | ◯ | ◯ |
| Example 6 | ◯ | ⊚ | ◯ | ◯ | ◯ | ◯ |
| Comparative | ◯ | ◯ | ◯ | ◯ | X | Δ-X |
| Example 1 | | | | | | |
| Comparative | ◯ | ◯ | ◯ | ◯ | X | X |
| Example 2 | | | | | | |
| Comparative | X | ◯ | ◯ | ◯ | ◯ | ◯ |
| Example 3 | | | | | | |

Referring to Table 1, the ink compositions of Examples 1 to 6 using the pigment have excellent color characteristics and the ink composition of Comparative Examples 1 and 2 show high contrast ratios. Comparative Example 3 in which the pigment is changed, however, shows a remarkably low contrast ratio.

On the other hand, the ink compositions of Examples 1 to 6 using the leveling agent according to the present invention have a remarkably low number of surface craters, but the ink composition of Comparative Example 1 in which the leveling agent is not used has many surface craters. Also, the ink composition of Comparative Example 2 in which the leveling agent is used but in a smaller amount also has many surface craters. The ink compositions of Examples 1 to 6 show excellent ejection properties, storage stability, and heat resistance compared to those of Comparative Examples 1 to 3.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A color filter ink composition comprising
an acryl-based resin, a polymerizable monomer, a pigment, a leveling agent, and a solvent,
wherein the pigment is represented by the following Chemical Formula 1, and the leveling agent is a polymer including a repeating unit comprising at least one of the following Chemical Formula 2, Chemical Formula 3, or combinations thereof: 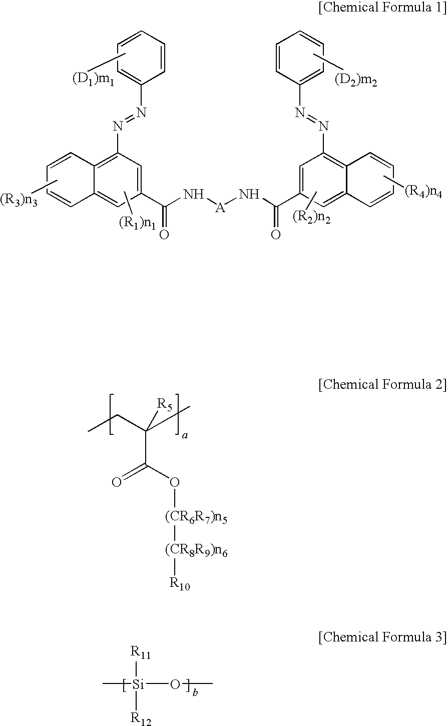
wherein, in the above Formulae 1 to 3,
A includes substituted or unsubstituted arylene, substituted or unsubstituted heteroarylene, substituted or unsubstituted cycloalkylene, substituted or unsubstituted heterocycloalkylene, or combinations thereof,
D₁ and D₂ are the same or different and independently include substituted or unsubstituted aryl, substituted or unsubstituted heteroaryl, substituted or unsubstituted cycloalkyl, substituted or unsubstituted heterocycloalkyl, or combinations thereof,
R₁ and R₂ are the same or different and independently include hydroxy, nitro, substituted or unsubstituted amino, cyano, carboxylic acid, or combinations thereof,
R₃ and R₄ are the same or different and independently include hydrogen, substituted or unsubstituted alkyl, substituted or unsubstituted aryl, or combinations thereof,
R₅ to R₇ and R₁₁ to R₁₂ are the same or different and independently include hydrogen, substituted or unsubstituted alkyl, or combinations thereof,
R₈ to R₁₀ are the same or different and independently include halogen, haloalkyl, and combinations thereof,
n₁ and n₂ are the same or different and are independently an integer of 1 or 2,
n₃ and n₄ are the same or different and are independently an integer ranging from 0 to 3,
n₅ is an integer ranging from 0 to 30,
n₆ is an integer ranging from 1 to 20,
m₁ and m₂ are the same of different and are independently an integer ranging from 1 to 5, and
a and b are the same of different and are independently an integer ranging from 1 to 50.

2. The color filter ink composition of claim 1, wherein the composition comprises:
(a) about 1 to about 40 wt % of the acryl-based resin;
(b) about 1 to about 40 wt % of the polymerizable monomer;
(c) about 1 to about 40 wt % of the pigment;
(d) about 0.001 to about 2 wt % of the leveling agent; and
(e) the balance of the solvent.

3. The color filter ink composition of claim 1, wherein the color filter ink composition further comprises about 1 to about 20 wt % of a co-pigment including C.I. pigment red No. 177, C.I. pigment yellow No. 138, C.I. pigment yellow No. 139, C.I pigment yellow No. 150, C.I. pigment orange No. 38, or combinations thereof.

4. The color filter ink composition of claim 1, wherein the solvent includes low boiling-point solvents, high boiling-point solvents, or combinations thereof.

5. The color filter ink composition of claim 1, wherein the color filter ink composition has interfacial tension of about 30 mN/m or less.

6. The color filter ink composition of claim 1, wherein the pigment comprises a compound including C.I. pigment red 242, C.I. pigment red 214, C.I. pigment red 221, C.I. pigment red 166, C.I. pigment red 220, C.I. pigment red 248, C.I. pigment red 262, or combinations thereof.

7. The color filter ink composition of claim 1, wherein A of Formula 1 includes:

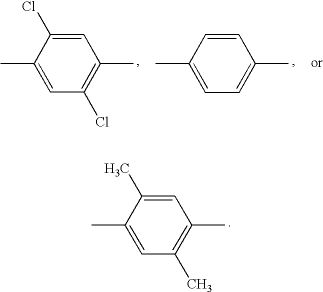

8. The color filter ink composition of claim 1, wherein each D₁ and D₂ of Formula 1 includes independently: 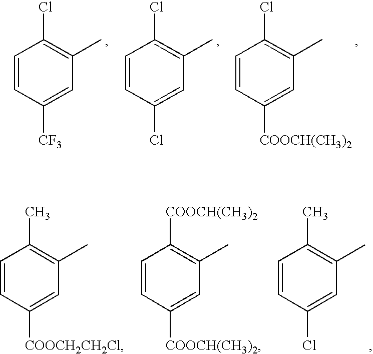
or combinations thereof.

9. The color filter ink composition of claim 1, wherein the pigment comprises a compound of Formula 4:

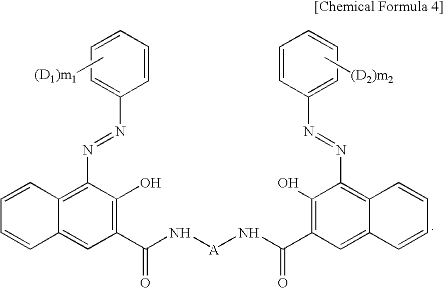

10. The color filter ink composition of claim 1, wherein the leveling agent is a polymer including a repeating unit represented by the following Formulae 5 and 6:

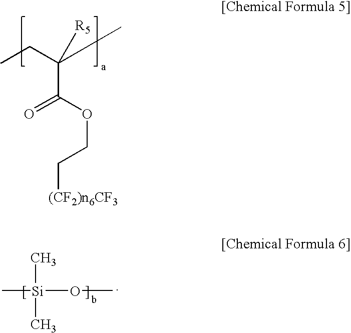

11. The color filter ink composition of claim 1, further comprising a polymerization initiator.

12. A method of making a color filter pixel, comprising:
coating the color filter ink composition according to claim 1 on a substrate using an Inkjet spraying method to form a pattern; and
curing the pattern.

13. The method of claim 12, wherein the curing step comprises thermally curing the pattern.

14. The method of claim 13, wherein the thermal curing is conducted at a temperature of about 160 to about 300° C.

15. A color filter comprising the color filter pixel made according to claim 12.
